(19) United States
(12) Patent Application Publication
(10) Pub. No.: US 2024/0394029 A1
(43) Pub. Date: Nov. 28, 2024

(54) DEVICE, INFORMATION PROCESSING APPARATUS, AND COMMUNICATION SYSTEM

(71) Applicant: Yuuya NAKAO, Kanagawa (JP)

(72) Inventor: Yuuya NAKAO, Kanagawa (JP)

(21) Appl. No.: 18/695,832

(22) PCT Filed: Sep. 15, 2022
(86) PCT No.: PCT/IB2022/058684

§ 371 Date: Mar. 27, 2024

(30) Foreign Application Priority Data
Oct. 18, 2021 (JP) 2021-170412

(51) Int. Cl. G06F 8/61; G06F 8/65; G06F 8/71

(52) U.S. Cl. CPC G06F 8/62; G06F 8/65; G06F 8/71

(57) ABSTRACT

A device for communicating, via a network, with at least one information processing apparatus that provides an application to the device, including: a communication unit configured to transmit, to the information processing apparatus, a request for information on an application installable onto the device or an application to be uninstalled from the device; and an installation control unit configured to perform at least one of a process of installing the application onto the device or a process of uninstalling the application from the device, in accordance with the information, on the application installable onto the device or the application to be uninstalled from the device, received from the information processing apparatus. The information processing apparatus, and a system including the device and the information processing apparatus are also provided.

### TECHNICAL FIELD

The present disclosure relates to a device, an information processing apparatus, and a communication system.

### BACKGROUND ART

Cloud services include services provided by an information processing apparatus to a device over a network. For example, there is a service in which in response to connection of a device at a company having a tenant contract to an information processing apparatus, the information processing apparatus provides desired processing to the device within a range of a license of the company. A technique of easily implementing provision of such cloud services is conceived (see, for example, PTL 1). PTL 1 discloses a technique of associating a cloud service and a device with each other.

### CITATION LIST

### Patent Literature

### [PTL 1]

Japanese Unexamined Patent Application Publication No. 2012-203430

### SUMMARY OF INVENTION

### Technical Problem

The technique of the related art, however, does not control installation or uninstallation of an application on the device. Thus, an end user or customer engineer is to operate the device to install or uninstall the application.

In view of the disadvantage described above, the present disclosure has an object to provide a device, an information processing system, and a communication system that control installation or uninstallation of an application to the device.

### Solution to Problem

In view of the disadvantage described above, an aspect of the present disclosure provides a device that communicates, via a network, with at least one information processing apparatus that provides an application to the device. The device includes a communication unit, and an installation control unit. The communication unit transmits, to the information processing apparatus, a request for information on an application installable onto the device or an application to be uninstalled from the device. The installation control unit performs at least one of a process of installing the application onto the device or a process of uninstalling the application from the device, in accordance with the information, on the application installable onto the device or the application to be uninstalled from the device, received from the information processing apparatus.

Another aspect of the present disclosure provides an information processing apparatus that provides an application to a device. The information processing apparatus includes a communication unit. The communication unit receives, from the device, a request for information on an application installable onto the device or an application to be uninstalled from the device, and transmits, to the device, the information on the application installable onto the device or the application to be uninstalled from the device.

Still another aspect of the present disclosure provides a communication system including a device, and at least one information processing apparatus that communicates with the device via a network and provides an application to the device. The device includes a communication unit, and an installation control unit. The communication unit transmits, to the information processing apparatus, a request for information on an application installable onto the device or an application to be uninstalled from the device. The installation control unit performs at least one of a process of installing the application onto the device or a process of uninstalling the application from the device, in accordance with the information, on the application installable onto the device or the application to be uninstalled from the device, received from the information processing apparatus.

### Advantageous Effects of Invention

A device, an information processing apparatus, and a communication system are provided that control installation or uninstallation of an application.

### BRIEF DESCRIPTION OF DRAWINGS

A more complete appreciation of the embodiments and many of the attendant advantages and features thereof can be readily obtained and understood from the following detailed description with reference to the accompanying drawings.

FIG. 1 is an example of a schematic configuration diagram for describing a procedure in which a device installs an application and uninstalls an application.

FIG. 2 is an example of a schematic configuration diagram of a communication system.

FIG. 3 is an example of a hardware configuration diagram of a computer.

FIG. 4 is an example of a hardware configuration diagram of a multifunction peripheral (MFP) that is an example of the device.

FIG. 5 is a diagram illustrating an example of a functional configuration of the communication system.

FIG. 6 is a diagram illustrating an example of installation information stored in an installation information storage unit.

FIG. 7 is a table illustrating an example of application information stored in an application processing information storage unit.

FIG. 8 is an example of a sequence diagram for describing a procedure in which the device controls installation and uninstallation of an application.

FIG. 9 is an example of a table illustrating information to be transmitted by the device to a second information processing system.

FIG. 10 is a table illustrating an example of application information returned by the second information processing system.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result. Referring now to the drawings, embodiments of the present disclosure are described below. As used herein, the singular forms “a,” “an,” and “the” are intended to include the plural forms as well, unless the context clearly indicates otherwise. A communication system and an application management method performed by the communication system according to an embodiment of the present disclosure will be described below with reference to the drawings.

### Overview of Operation

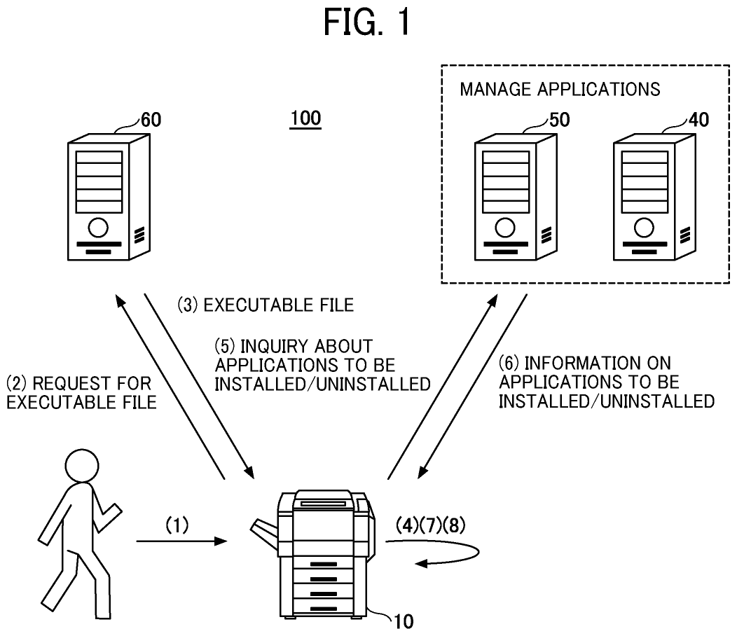

FIG. 1 is a schematic configuration diagram for describing a procedure in which a device 10 installs an application and uninstalls an application in accordance with an embodiment of the present disclosure.

(1) A user operates a management application that runs on the device 10 to perform an operation of installing an application managed by a first information processing system 40 or a second information processing system 50.

(2) The management application transmits a request for an executable file of the application to a file management server 60.

(3) The file management server 60 transmits the executable file to the device 10.

(4) In response to installation of the application (execution of the executable file) on the device 10, the management application stores which of the first information processing system 40 or the second information processing system 50 manages the installed application.

(5) At a predetermined timing such as once a day, the device 10 transmits, to the second information processing system 50, an inquiry about an application installable onto the device 10 and an application to be uninstalled from the device 10. These applications are determined based on a tenant contract.

(6) Based on the tenant contract of the tenant to which the device 10 belongs, the second information processing system 50 transmits, to the device 10, information on an application installable onto the device 10 and an application to be uninstalled from the device 10.

(7) The management application acquires a list of library-handled applications from metadata of the applications stored in the device 10. A library-handled application, details of which will be described later, is an application in which a library is incorporated.

(8) The device 10 uninstalls an application that is not a library-handled application, that is to be uninstalled (because the contract period has expired), and was installed from the first information processing system 40.

If there is any installable application, the device 10 downloads an executable file of the application from the file management server 60 and installs the application onto the device 10.

Thus, the device 10 according to the embodiment of the present disclosure successfully controls uninstallation of an application installed on the device 10, for example, based on a contract period of the application subjected to the tenant contract. The device 10 also successfully installs an application automatically.

### Terminology

The term “tenant” refers to an organization such as a company or local government that has a contract to receive a service from a service provider (application distributer in the embodiment of the present disclosure). In one example, users or devices belong to a tenant. In another example, an individual user may subscribe a service.

The term “application” refers to software that is not intended for operations of a computer but is developed and used for a certain function or purpose. Such applications include a native application and a web application.

The term “contract state” refers to details of a contract if a tenant is authorized to use an application by the contract. The contract state may include information on a contract period, a free use period, the number of permitted accounts, and restricted functions, for example. The expression “being authorized to use an application by a contract” is synonymous to “having a license”.

The term “to install” refers to introducing a program or application onto a computer system and performing a configuration to make the program or application usable. The term “to uninstall” refers to deleting a program or application from the computer system or making the program or application unusable.

### Example of System Configuration

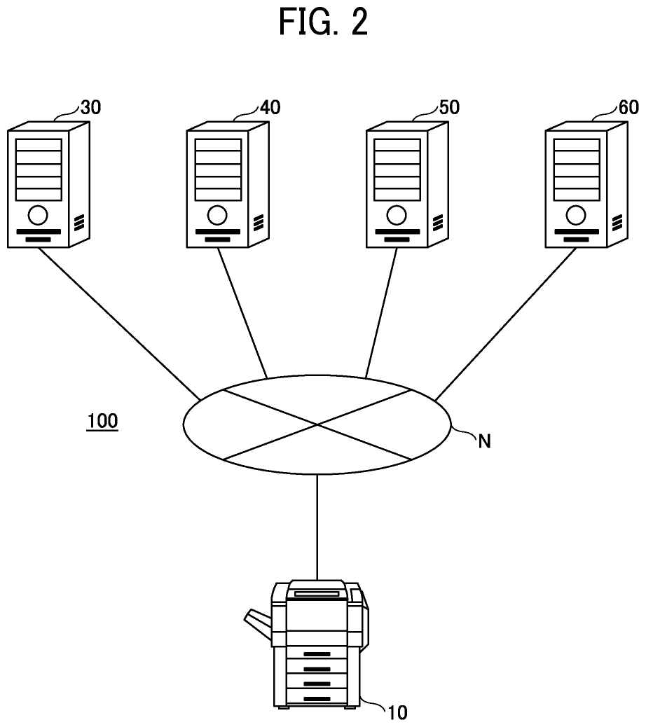

FIG. 2 is a schematic configuration diagram of a communication system 100 according to the embodiment of the present disclosure. The communication system 100 includes an application releasing system 30, the first information processing system 40, the second information processing system 50, the file management server 60, and the device 10 that communicate with each other via a network N.

The application releasing system 30 includes one or more information processing apparatuses. The application releasing system 30 provides a web site on which applications registered to the file management server 60 are released. A customer engineer, a sales person, or a designer accesses the application releasing system 30 from the device 10 to browse a list of the applications.

The first information processing system 40 includes one or more information processing apparatuses. The first information processing system 40 manages, as a tenant, a customer that uses the device 10. The customer is, for example, an organization such as a company having a contract to receive a service as a tenant. The first information processing system 40 receives registration of a customer to the tenant, receives a package of applications subjected to the contract of the customer, and makes the package available to the tenant of the customer. The term “package” refers to a combination of multiple applications bundled by taking usability or the like into account. The tenant assigned to the customer is associated with the device 10. The device 10 installs the package subjected to the contract of the customer as the tenant onto the device 10.

The second information processing system 50 includes one or more information processing apparatuses. To describe the second information processing system 50, the management application will be described. The management application is an application that receives, from a user, selection of an application to be installed onto the device 10 among various applications. The device 10 executes the management application. The second information processing system 50 includes information on a web page to be displayed by the management application via a web browser. The management application uses a web browser function provided by an operating system (OS) to display a screen based on the information acquired from the second information processing system 50. For example, the management application accesses the second information processing system 50. The second information processing system 50 then acquires application information to be displayed by the management application from the application releasing system 30. The management application then acquires the application information and displays, based on the application information, (released) applications installable onto the device 10. The management application also starts a check of a contract at night.

The file management server 60 is an information processing apparatus that stores executable files (binary files) of applications. The file management server 60 is disposed on the premises. The file management server 60 may be disposed in cloud.

The device 10 is, for example, an MFP. The MFP provides multiple functions such as copy, scan, fax, and print functions. The MFP may be referred to as a multifunctional device, an image forming apparatus, a printing apparatus, a printer, or the like. The device 10 is an example of various electronic devices used by users. The device 10 may be, for example, a projector, an electronic whiteboard, a video conference terminal, or a digital camera. The device 10 may be any device on which an application runs and that has a web browser or a function equivalent to the web browser.

FIG. 2 illustrates the application releasing system 30, the first information processing system 40, the second information processing system 50, and the file management server 60 separately from one another. However, the application releasing system 30, the first information processing system 40, the second information processing system 50, and the file management server 60 may be integrated into one or more information processing apparatuses. Conversely, functions of one or more of the application releasing system 30, the first information processing system 40, the second information processing system 50, and the file management server 60 may be distributed to multiple information processing apparatuses.

### Example of Hardware Configuration

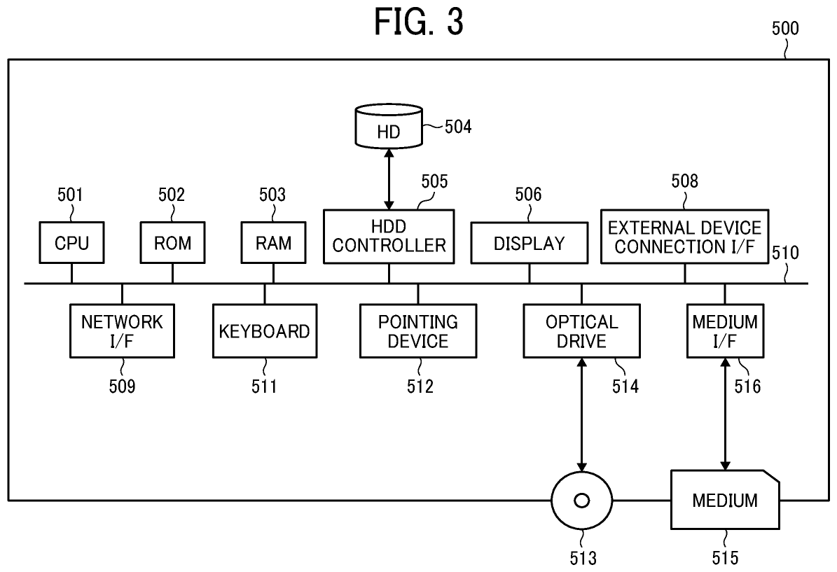

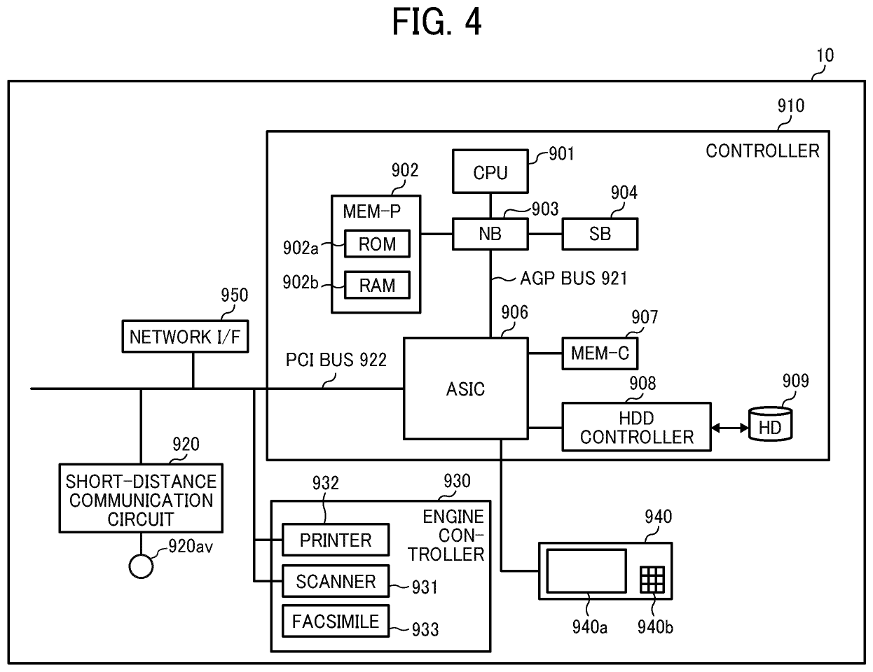

Hardware configurations of the application releasing system 30, the first information processing system 40, the second information processing system 50, the file management server 60, and the device 10 according to the embodiment of the present disclosure will be described with reference to FIGS. 3 and 4.

### Application Releasing System, First Information Processing System, Second Information Processing System, and File Management Server

FIG. 3 is a block diagram illustrating an example of a hardware configuration of a computer 500 according to the embodiment of the present disclosure. Each of the application releasing system 30, the first information processing system 40, the second information processing system 50, and the file management server 60 is constructed by the computer 500 having the structure illustrated in FIG. 3. The computer 500 includes a central processing unit (CPU) 501, a read-only memory (ROM) 502, a random access memory (RAM) 503, a hard disk (HD) 504, a hard disk drive (HDD) controller 505, a display 506, an external device connection interface (I/F) 508, a network I/F 509, a bus line 510, a keyboard 511, a pointing device 512, an optical drive 514, and a medium I/F 516.

The CPU 501 controls entire operation of the computer 500. The ROM 502 stores a program for controlling the CPU 501, such as an initial program loader (IPL). The RAM 503 is used as a work area for the CPU 501. The HD 504 stores various kinds of data such as a program. The HDD controller 505 controls reading and writing of various kinds of data from and to the HD 504 under control of the CPU 501. The display 506 displays various kinds of information such as a cursor, a menu, a window, characters, or an image. The external device connection I/F 508 is an interface that connects various external devices to the computer 500. Examples of the external devices in this case include a Universal Serial Bus (USB) memory and a printer. The network I/F 509 is an interface for performing data communication via the network N. The bus line 510 is a bus such as an address bus or data bus that electrically connects the components such as the CPU 501 illustrated in FIG. 3 to one another.

The keyboard 511 is an example of an input device provided with a plurality of keys used to input characters, numerals, or various instructions. The pointing device 512 is an example of an input device used to select or execute various instructions, select a target for processing, or move a cursor. The optical drive 514 reads and writes various kinds of data from and to an optical recording medium 513, which is an example of a removable recording medium. Examples of the optical recording medium include a compact disc (CD), a DVD, and a Blu-ray Disc®. The medium I/F 516 controls reading and writing (storing) of data from and to a recording medium 515 such as a flash memory.

### Device

FIG. 4 is a hardware configuration diagram of an MFP that is an example of the device 10 according to the embodiment of the present disclosure. As illustrated in FIG. 4, the MFP includes a controller 910, a short-range communication circuit 920, an engine controller 930, an operation panel 940, and a network I/F 950.

The controller 910 includes a CPU 901 as a main processor, a system memory (MEM-P) 902, a north bridge (NB) 903, a south bridge (SB) 904, an application specific integrated circuit (ASIC) 906, a local memory (MEM-C) 907 as a memory, a HDD controller 908, and an HD 909 as a memory. The NB 903 and the ASIC 906 are connected to each other through an accelerated graphics port (AGP) bus 921.

The CPU 901 is a controller that controls entire operation of the MFP. The NB 903 connects the CPU 901 to the MEM-P 902, the SB 904, and the AGP bus 921. The NB 903 includes a memory controller that controls reading and writing of various kinds of data from and to the MEM-P 902, a Peripheral Component Interconnect (PCI) master, and an AGP target.

The MEM-P 902 includes a ROM 902a as a memory that stores a program and data for implementing various functions of the controller 910. The MEM-P 902 further includes a RAM 902b as a memory that deploys the program and data and as a drawing memory that stores drawing data for printing. The program stored in the RAM 902b may be stored in any computer-readable recording medium, such as a CD-ROM, CD-R, or DVD, as an installable or executable file, for distribution.

The SB 904 connects the NB 903 to a PCI device and a peripheral device. The ASIC 906 is an integrated circuit (IC) dedicated to an image processing use and including hardware elements for image processing. The ASIC 906 connects the AGP bus 921, a PCI bus 922, the HDD controller 908, and the MEM-C 907 to each other. The ASIC 906 includes a PCI target, an AGP master, an arbiter (ARB) as a central processor of the ASIC 906, a memory controller, a plurality of direct memory access controllers (DMACs), and a PCI unit. The memory controller controls the MEM-C 907. The DMACs perform rotation of image data with a hardware logic. The PCI unit transfers data to a scanner controller (scanner) 931, a printer controller (printer) 932, and a facsimile controller (facsimile) 933 through the PCI bus 922. The ASIC 906 may include a USB interface or an Institute of Electrical and Electronics Engineers 1394 (IEEE1394) interface.

The MEM-C 907 is a local memory used as a buffer for image data to be copied or a code buffer. The HD 909 stores image data, font data for printing, and form data. The HDD controller 908 controls reading and writing of data from and to the HD 909 under control of the CPU 901. The AGP bus 921 is a bus interface for a graphics accelerator card, which has been proposed to accelerate graphics processing. Through directly accessing the MEM-P 902 by high-throughput, the speed of the graphics accelerator card is improved.

The short-range communication circuit 920 is provided with a short-range communication circuit antenna 920a. The short-range communication circuit 920 is a communication circuit that is compliant with Near Field Communication (NFC), Bluetooth®, or the like.

The engine controller 930 includes the scanner controller 931, the printer controller 932, and the facsimile controller 933. The operation panel 940 includes a panel display 940a such as a touch panel, and a hardware keypad 940b. The panel display 940a displays a screen of current setting values, a selection screen, and so on and receives input from an operator. The hardware keypad 940b includes, for example, numeral buttons that accept setting values of image forming conditions such as color density setting conditions and a start button that accepts a copy start instruction or the like. The controller 910 controls entire operation of the MFP. For example, the controller 910 controls drawing, communication, or user inputs to the operation panel 940. The scanner controller 931 or the printer controller 932 includes an image processor for error diffusion, gamma conversion, or the like.

In response to an instruction to select a specific application through the operation panel 940, for example, using a mode switch key, the MFP selectively performs a document box function, a copier function, a printer function, and a facsimile function. If the user selects the document box function, the MFP enters a document box mode. If the user selects the copier function, the MFP enters a copier mode. If the user selects the printer function, the MFP enters a printer mode. If the user selects the facsimile function, the MFP enters a facsimile mode.

The network I/F 950 is an interface for performing data communication via the network N. The short-range communication circuit 920 and the network I/F 950 are electrically connected to the ASIC 906 through the PCI bus 922.

### Functions

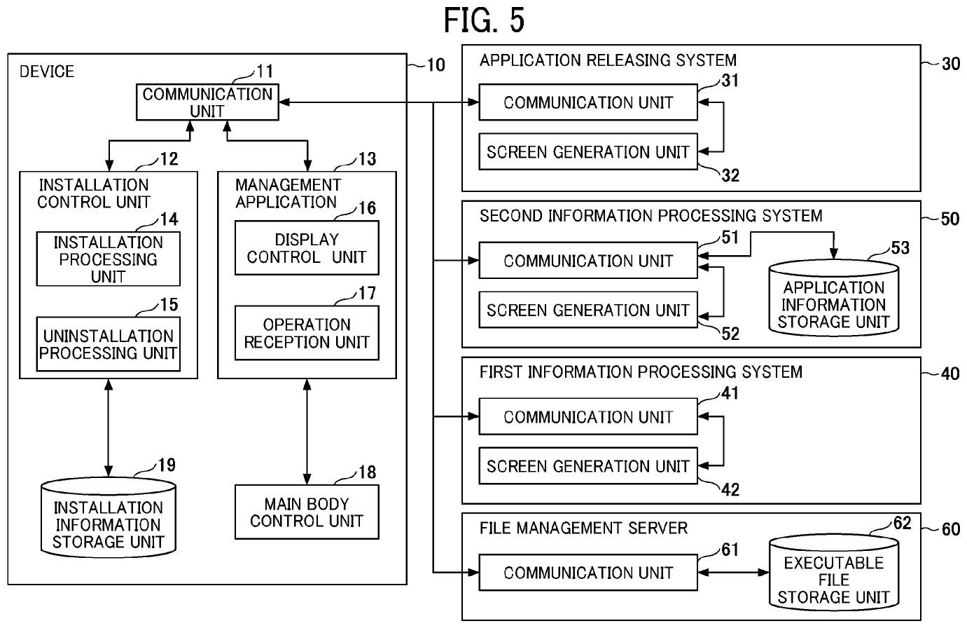

A functional configuration of the communication system 100 according to the embodiment of the present disclosure will be described next with reference to FIG. 5. FIG. 5 is a block diagram illustrating an example of a functional configuration of the communication system 100 according to the embodiment of the present disclosure.

### Device

The device 10 includes a communication unit 11, an installation control unit 12, a management application 13, and a main body control unit 18. The installation control unit 12 includes an installation processing unit 14 and an uninstallation processing unit 15. The management application 13 includes a display control unit 16 and an operation reception unit 17. The communication unit 11 is a function or functional unit implemented as a result of the CPU 901 illustrated in FIG. 4 executing commands included in a program installed on the device 10. The installation processing unit 14 and the uninstallation processing unit 15 are functions or functional units implemented as a result of the CPU 901 illustrated in FIG. 4 executing commands included in the installation control unit 12 (program) installed on the device 10. The display control unit 16 and the operation reception unit 17 are functions or functional units implemented as a result of the CPU 901 illustrated in FIG. 4 executing commands included in the management application 13 installed on the device 10.

The communication unit 11 transmits and receives various kinds of information to and from the application releasing system 30, the first information processing system 40, the second information processing system 50, and the file management server 60.

The installation processing unit 14 installs an application onto the device 10 and stores information on the installed application in an installation information storage unit 19. The uninstallation processing unit 15 uninstalls an application installed on the device 10. The installation processing unit 14 also updates firmware as appropriate.

The display control unit 16 uses a web browser function provided by the OS to display a web page provided by the application releasing system 30, the first information processing system 40, and the second information processing system 50. The management application 13 operates in cooperation with the application releasing system 30, the first information processing system 40, and the second information processing system 50 to implement a web application. The term “web application” refers to software that runs on a web browser and operates as a result of cooperation of a program written in a programming language and operating on the web browser and a program residing in a web server, or a mechanism of such software. A web application dynamically changes the web page.

The operation reception unit 17 receives various user operations performed on various screens displayed on the panel display 940a.

The main body control unit 18 controls native functions of the device 10 such as a function of controlling an engine such as a copier of the device 10.

The device 10 also includes the installation information storage unit 19 constructed in the HD 909 illustrated in FIG. 4 or the like.

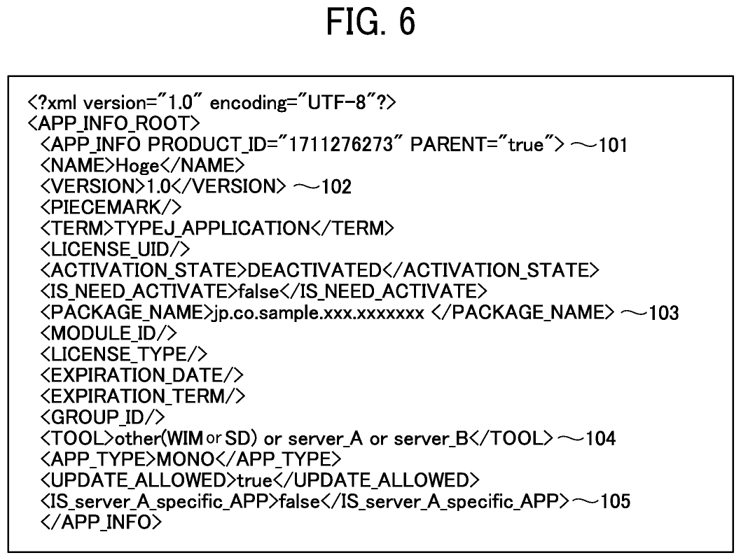

FIG. 6 illustrates an example of the installation information stored in the installation information storage unit 19. The installation information is information on an application installed on the device 10. The installation information is held for each application. Description related to the present embodiment in the installation information will be described below.

### <APP_INFO PRODUCT_ID=“1711276273” PARENT=“true”> 101

“APP_INFO PRODUCT_ID” indicates a product ID (identification information) of an application and associates the product ID with an executable file stored in the file management server 60.

### <VERSION>1.0</VERSION> 102

“VERSION” indicates a version of the application.

<PACKAGE_NAME>jp.co.sample.xxx.xxxxxxx</PACKAGE_NAME> 103

“PACKAGE_NAME” indicates a package name of the application.

<TOOL>other (WIM or SD) or server_A or server_B</TOOL> 104

This information indicates a source from which the application has been installed. “WIM” indicates that the application has been installed from an installation package. “SD®” indicates that the application has been installed from a memory card. “server_A” indicates that the application has been installed from the first information processing system 40. “server_B” indicates that the application has been installed from the second information processing system 50.

### <IS_server_A_specific_APP>false</IS_server_A_specific_APP> 105

This information indicates whether the application is a library-handled application. The term “library-handled application” refers to an application in which a specific library is incorporated. The specific library may be any library and is, for example, a library for authentication. A library-handled application is not to be uninstalled because the specific library controls the start of the library-handled application.

### Application Releasing System

Referring back to FIG. 5, further description is given. The application releasing system 30 includes a communication unit 31 and a screen generation unit 32. These functions of the application releasing system 30 are functions or functional units implemented as a result of the CPU 501 illustrated in FIG. 3 executing commands included in a program installed on the application releasing system 30.

The communication unit 31 communicates with the device 10, the first information processing system 40, the second information processing system 50, and the file management server 60. The screen generation unit 32 generates screen information of various screens to be displayed by the device 10. The screen information is a program written in HyperText Markup Language (HTML), Extensible Markup Language (XML), a script language, Cascading Style Sheet (CSS), and the like. In the screen information, the structure of a web page is defined by the HTML, the operation of the web page is defined by the script language, and the style of the web page is defined by the CSS.

### Second Information Processing System

The second information processing system 50 includes a communication unit 51 and a screen generation unit 52. These functions of the second information processing system 50 are functions or functional units implemented as a result of the CPU 501 illustrated in FIG. 3 executing commands included in a program installed on the second information processing system 50.

The communication unit 51 communicates with the device 10, the application releasing system 30, the first information processing system 40, and the file management server 60. The screen generation unit 52 generates screen information of various screens to be displayed by the device 10.

The second information processing system 50 also includes an application information storage unit 53 constructed in the HD 504 or the RAM 503 illustrated in FIG. 3.

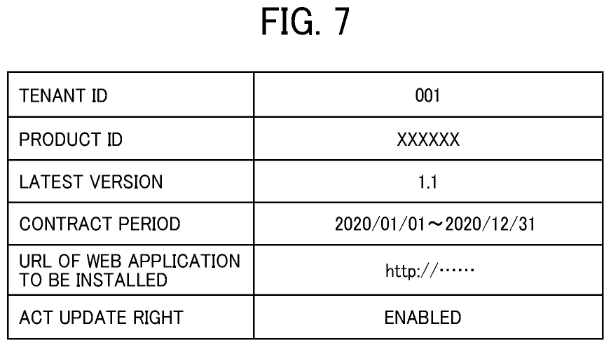

FIG. 7 illustrates an example of application information stored in the application information storage unit 53. The application information storage unit 53 stores information on an application subjected to the contract of a tenant.

A tenant ID is identification information of the tenant to which a user (employee of a customer) or a device belongs.

A product ID is identification information of an application subjected to the contract of the tenant. A latest version indicates a version number of the latest version of the application, which is available.

A contract period is a period for which the device 10 is permitted to use the application.

A Uniform Resource Locator (URL) of a web browser to be installed is a location at which the application to be installed on the device 10 of the tenant is provided, which may be a source from which the application is transmitted or provided.

ACT update right indicates whether the device 10 has a right to use the released latest function.

### First Information Processing System

The first information processing system 40 includes a communication unit 41 and a screen generation unit 42. These functions of the first information processing system 40 are functions or functional units implemented as a result of the CPU 501 illustrated in FIG. 3 executing commands included in a program installed on the first information processing system 40.

The communication unit 41 communicates with the device 10, the application releasing system 30, the second information processing system 50, and the file management server 60. The screen generation unit 42 generates screen information of various screens to be displayed by the device 10.

### File Management Server

The file management server 60 includes a communication unit 61. This function of the file management server 60 is a function or functional unit implemented as a result of the CPU 501 illustrated in FIG. 3 executing commands included in a program installed on the file management server 60.

The communication unit 61 communicates with the device 10, the application releasing system 30, the first information processing system 40, and the second information processing system 50. The file management server 60 includes an executable file storage unit 62. The executable file storage unit 62 stores an executable file of an application. The communication unit 61 transmits the executable file to the device 10 or the like in response to a request.

### Operation Procedure of Communication System

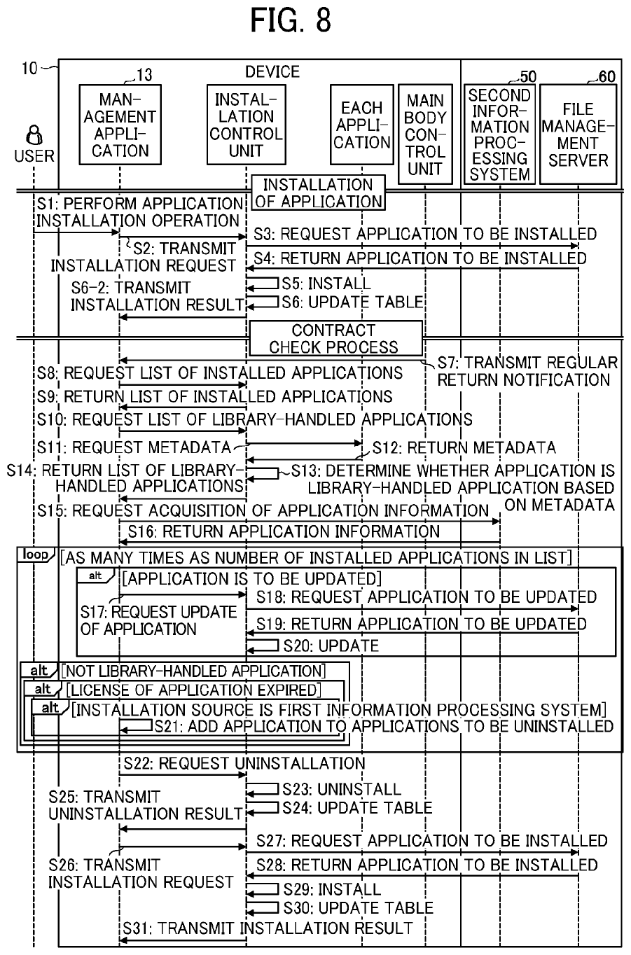

FIG. 8 is an example of a sequence diagram for describing a procedure in which the device 10 according to the embodiment of the present disclosure controls installation and uninstallation of an application.

The management application 13 is started in advance on the device 10. Steps S1 to S6-2 describe a process of manually installing an application.

S1: When the user installs an application from the second information processing system 50, the user displays a list of applications acquired by the management application 13 through accessing the second information processing system 50. The user selects a desired application.

S2: The operation reception unit 17 of the management application 13 receives the selection of the application, and the management application 13 transmits an installation request of the selected application to the installation control unit 12.

S3: The installation processing unit 14 of the installation control unit 12 transmits, to the file management server 60, a request for the application to be installed.

S4: The communication unit 61 of the file management server 60 transmits, to the device 10, an executable file of the requested application to be installed.

S5: The communication unit 11 of the device 10 receives the executable file, and the installation processing unit 14 executes the executable file to install the requested application onto the device 10.

S6: The installation processing unit 14 stores installation information of the application in the installation information storage unit 19. At this time, “server_B” is stored in the “TOOL” tag. As the item “IS_server_A_specific_APP” of the installation information stored in the installation information storage unit 19, “true” or “false” is set which is determined based on whether the executable file includes a specific library.

If the user installs an application from the first information processing system 40, the user uses an installation application (hereinafter, referred to as “browser application”) different from the management application 13 to install the application. In this case, the browser application accesses the first information processing system 40 and displays a list of applications. In response to the user selecting a desired application, the browser application transmits an installation request to the installation control unit 12 via the management application 13. Thus, the management application 13 installs the application.

When storing information indicating from which of the management application 13 (corresponding to the second information processing system 50) and the browser application (corresponding to the first information processing system 40) the application has been installed, the installation control unit 12 stores, based on the information acquired from the management application 13, in the installation information storage unit 19, information indicating from which of the second information processing system 50 or the first information processing system 40 the application has been installed in step S6.

Specifically, the management application 13 transmits an action name to the installation control unit 12 when transmitting the installation request to the installation control unit 12. In accordance with the action name, the installation control unit 12 stores information on from which of the second information processing system 50 or the first information processing system 40 the application has been installed in the installation information storage unit 19. The action name changes depending on whether the management application 13 has directly received an application installation operation or the management application 13 has received the application installation operation via the browser application.

S6-2: The installation processing unit 14 transmits an installation result (success or failure) to the management application 13. The installation information may include the name of the installed application and “success” or “failure”, for example.

Steps S7 to S16 describe a process of checking the contract related to the application.

S7: The main body control unit 18 transmits a regular return notification to the management application 13 at a preset time. The regular return notification indicates a return of the device 10 from a power-save mode to perform a diagnosis of the device 10 or log management at a time such as nighttime when the device 10 is not used.

S8: In response to the regular return notification, the management application 13 transmits, to the installation control unit 12, a request for a list of installed applications.

S9: The installation control unit 12 acquires installation information of each application from the installation information storage unit 19 and returns the list of installed applications to the management application 13.

S10: The management application 13 transmits, to the installation control unit 12, a request for a list of library-handled applications.

S11, S12: The installation control unit 12 acquires metadata from each application.

In FIG. 8, the installation control unit 12 requests each application to provide the metadata. Alternatively, the OS sometimes manages the metadata. If the OS is Android®, the OS stores the metadata in an application database called manifest. The manifest is written in the XML format. For example, the installation control unit 12 determines whether an application is a library-handled application depending on whether the “application” tag includes a description “specific” (or “specific library”).

S13: The installation control unit 12 determines whether each application is a library-handled application with reference to the corresponding metadata.

S14: The installation control unit 12 returns the list of library-handled applications to the management application 13.

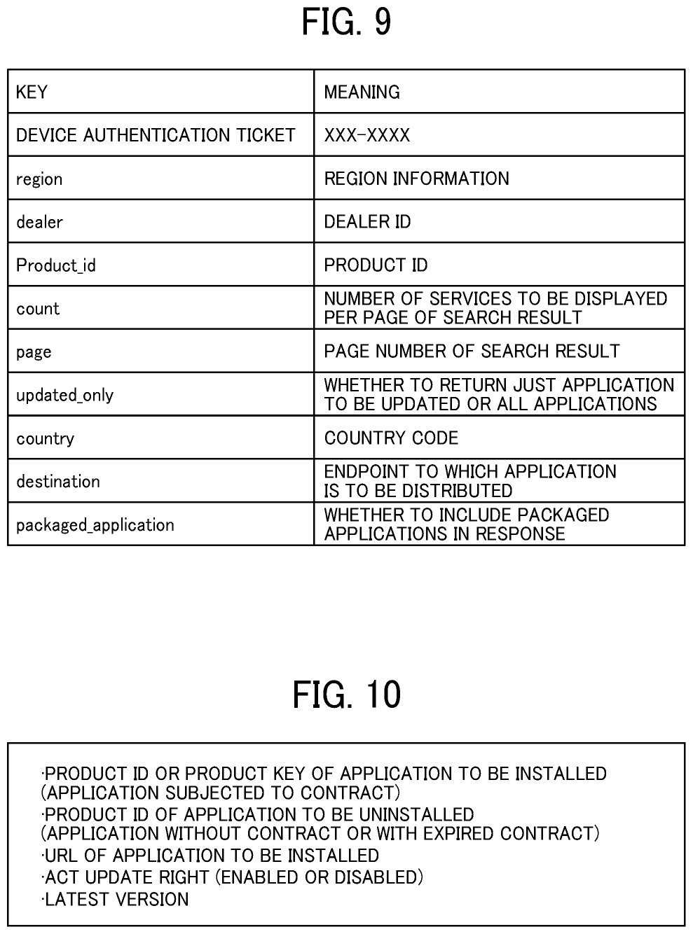

S15: To identify an installable application and an application to be uninstalled, the management application 13 transmits a request for application information to the second information processing system 50. To acquire the application information, the management application 13 transmits information illustrated in FIG. 9 to the second information processing system 50.

FIG. 9 illustrates an example of the information transmitted by the device 10 to the second information processing system 50. FIG. 9 presents a name of each item and a description of the item. In response to the device 10 transmitting this information to the second information processing system 50, an application installable onto the device 10 and an application to be uninstalled from the device 10 are identified.

An item “device authentication ticket” is information certifying that the device 10 is a device having the tenant contract. The device authentication ticket is attached to a request header, for example. The device authentication ticket allows the second information processing system 50 to identify the tenant. The device authentication ticket also reveals applications subjected to the contract of this tenant.

An item “region” is region information and indicates a region (such as North America, Europe (EU), or Asia) in the world. That is, the item “region” indicates a region where the application is used.

An item “dealer” is identification information of a dealer that sells the device 10 onto which the application is to be installed.

An item “Product_id” is a product ID of the application and identification information for uniquely identifying the installed application.

An item “count” indicates the number of services to be displayed per page of the search result.

An item “page” indicates whether to display the page number of the search result.

An item “updated_only” indicates whether to return just an application to be updated or return all the applications.

An item “country” indicates a country code.

An item “destination” indicates an endpoint to which the application is to be distributed. For example, if servers reside in Europe and Japan, the servers have different URLs. Since the URL of the server changes depending on the location of the customer (the device 10), the item “destination” specifies the server.

An item “packaged_application” sets whether to include a packaged application in the response.

In the embodiment of the present disclosure, the management application 13 acquires the application information from the second information processing system 50 but may acquire the application information also from the first information processing system 40.

S16: Referring back to FIG. 8, the description is continued. The communication unit 51 of the second information processing system 50 receives the request for the application information. The communication unit 51 transmits the application information of the requested application to the device 10. FIG. 10 illustrates an example of the application information returned by the second information processing system 50.

As illustrated in FIG. 10, for example, the application information returned by the second information processing system 50 includes items as follows:
Product ID or product key of an application to be installed (application subjected to the contract): this information is identification information of an installable application or key information for use in installation;
Product ID of an application to be uninstalled (application without any contract or subjected to the expired contract): this information is key information of an application to be uninstalled;
Latest version of the application: this information indicates the latest version of each application;
URL of a web application to be installed: this information indicates the URL from which each application is to be acquired; and
ACT update right (enabled or disabled): If the ACT update right is enabled, automatic installation of the latest function is enabled. Thus, in response to a release of the latest function, the management application 13 automatically installs the function to the device 10. This allows the user to use the latest functions without any action.

S17: Referring back to FIG. 8, the description is continued. The management application 13 compares the version information included in the application information acquired in step S16 with the version information of the installed application. If there is an application of the version that is not the latest (if the version of the application installed on the device 10 is older than the latest version), the management application 13 transmits a request to update the application to the installation control unit 12.

S18: The installation processing unit 14 of the installation control unit 12 transmits, to the file management server 60, a request for an executable file of the application to be updated.

S19: The communication unit 61 of the file management server 60 transmits the requested executable file of the application to be updated to the device 10.

S20: The communication unit 11 of the device 10 receives the executable file, and the installation processing unit 14 executes the executable file to install the latest version of the application onto the device 10.

S21: The management application 13 adds, to an uninstallation list, the application that is not a library-handled application, have an expired contract period, and have been installed from the first information processing system 40. A library-handled application is not to be uninstalled because the library controls the library-handled application to be unusable. At the start of a library-handled application, the library receives, from the library-handled application, association information for associating the library-handled application with the first information processing system 40 (for example, a client ID of the library-handled application and destination information of the first information processing system 40). Based on this association information, the library transmits an inquiry to the first information processing system 40. If the library-handled application is usable, the library starts the app; otherwise, the library does not start the application.

The library-handled application also displays a message to prompt a re-contract.

The application installed from the first information processing system 40 is uninstalled because of the following reason. The contract of the application is usually renewed monthly or yearly. Thus, the application is to be made unusable if the tenant cancels the contract or the contract period expires without renewal. Whether the application is installed from the first information processing system 40 is determined from “server_A” set in “<TOOL>other (WIM or SD) or server_A or server_B</TOOL>” of the installation information. Whether the contract period of the application has expired is determined since the application is designated as an application to be uninstalled as illustrated in FIG. 10.

S22: The management application 13 designates the uninstallation list and requests the installation control unit 12 to uninstall the application.

S23: The uninstallation processing unit 15 of the installation control unit 12 uninstalls the application designated by the uninstallation list.

S24: The uninstallation processing unit 15 updates the installation information of the uninstalled application. For example, the uninstallation processing unit 15 may delete the installation information or may register “deleted” in the installation information.

S25: The installation control unit 12 transmits an uninstallation result to the management application 13. The uninstallation result may include the name of the uninstalled application and “success” or “failure”, for example.

S26: If the application information acquired in step S16 indicates the presence of an installable application, the management application 13 requests the installation control unit 12 to install the application. The application information illustrated in FIG. 10 includes the installable application as the application to be installed. This application has not been installed onto the device 10.

Processing of steps S27 to S31 may be the same as or similar to the processing of steps S3 to S6-2.

As described above, the device 10 according to the embodiment of the present disclosure successfully uninstalls an application installed on the device 10 in accordance with whether the application is a library-handled application, whether there is a contract, and an installation source. The device 10 successfully automatically installs an application subjected to a contract of the device 10 and not installed yet.

While the present disclosure has been described above using the embodiment, the embodiment does not limit the present disclosure in any way. Various modifications and replacements may be made within a scope not departing from the gist of the present disclosure.

For example, installation/uninstallation of an application onto/from an MFP which is the device 10 has been described in the embodiment of the present disclosure. However, the device 10 may be any information processing apparatus on which an application runs.

The device 10 determines an application to be installed/uninstalled in the embodiment of the present disclosure. However, a server may make this determination.

Division of blocks in the functional block diagram illustrated in FIG. 5 is an example. A plurality of blocks may implemented as a single block, a single block may be divided into a plurality of blocks, or part of a function of a block may be transferred to another block. In addition, functions of a plurality of blocks having similar functions may be processed by a single piece of hardware or software in parallel or in a time division manner.

The apparatuses or devices described in one or more embodiments are just one example of plural computing environments that implement the one or more embodiments disclosed herein. In one embodiment, the first information processing system 40 and the second information processing system 50 each include multiple computing devices such as a server cluster. The multiple computing devices communicate with one another through any type of communication link, including a network, a shared memory, or the like and perform processes disclosed herein.

The first information processing system 40 and the second information processing system 50 share processing steps disclosed in the embodiment, for example, processing steps in FIG. 8 in various combinations. For example, a process performed by a certain unit may be performed by a plurality of information processing apparatuses of the first information processing system 40 and the second information processing system 50. The first information processing system 40 and the second information processing system 50 may be implemented by a single server apparatus or may be distributed to a plurality of apparatuses.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The present invention can be implemented in any convenient form, for example using dedicated hardware, or a mixture of dedicated hardware and software. The present invention may be implemented as computer software implemented by one or more networked processing apparatuses. The processing apparatuses include any suitably programmed apparatuses such as a general purpose computer, a personal digital assistant, a Wireless Application Protocol (WAP) or third-generation (3G)-compliant mobile telephone, and so on. Since the present invention can be implemented as software, each and every aspect of the present invention thus encompasses computer software implementable on a programmable device. The computer software can be provided to the programmable device using any conventional carrier medium (carrier means). The carrier medium includes a transient carrier medium such as an electrical, optical, microwave, acoustic or radio frequency signal carrying the computer code. An example of such a transient medium is a Transmission Control Protocol/Internet Protocol (TCP/IP) signal carrying computer code over an IP network, such as the Internet. The carrier medium also includes a storage medium for storing processor readable code such as a floppy disk, a hard disk, a compact disc read-only memory (CD-ROM), a magnetic tape device, or a solid state memory device.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

This patent application is based on and claims priority to Japanese Patent Application No. 2021-170412, filed on Oct. 18, 2021, in the Japan Patent Office, the entire disclosure of which is hereby incorporated by reference herein.

### REFERENCE SIGNS LIST

10 device
11 communication unit
12 installation control unit
14 installation processing unit
15 uninstallation processing unit
30 application releasing system
40 first information processing system
50 second information processing system
60 file management server

1-9. (canceled)

10. A device for communicating, via a network, with at least one information processing apparatus that provides an application to the device, the device comprising:
communication circuitry configured to transmit, to the information processing apparatus, a request for information on an application installable onto the device or information of an application to be uninstalled from the device; and
installation control circuitry configured to perform at least one of a process of installing the application onto the device or a process of uninstalling the application from the device, in accordance with the information, on the application installable onto the device or the application to be uninstalled from the device, received from the information processing apparatus,
wherein the installation control circuitry is configured to uninstall the application based on source information indicating an installation source of the application installed on the device, in addition to the information received from the information processing apparatus.

11. The device according to claim 10, wherein the application to be uninstalled includes an application for which a contract period of a tenant to which the device belongs has expired, and
wherein the installation control circuitry includes uninstallation processing circuitry configured to uninstall the application to be uninstalled.

12. The device according to claim 11, wherein the source information is stored in the device.

13. The device according to claim 12, wherein in a case where a predetermined library is not incorporated in the application installed on the device, the uninstallation processing circuitry is configured to uninstall the application installed on the device.

14. The device according to claim 11, wherein the uninstallation processing circuitry is configured to uninstall the application for which the contract period of the tenant has expired, which is installed from an installation source, and in which a predetermined library is not incorporated.

15. The device according to claim 10, wherein the application installable onto the device includes an application for which a contract period of a tenant to which the device belongs is valid, and
wherein the installation control circuitry includes an installation processing circuitry configured to install the installable application.

16. The device according to claim 15, wherein the communication circuitry is configured to receive, from the information processing apparatus, information on a latest version of the application installable onto the device,
wherein in a case where a version of the application installed on the device is older than the latest version, the installation processing circuitry is configured to transmit a request for updating the installed application to the information processing apparatus, and install the latest version of the application received from the information processing apparatus.

17. An information processing apparatus for providing an application to a device, the information processing apparatus comprising:
communication circuitry configured to receive, from the device, a request for information on an application installable onto the device or information of an application to be uninstalled from the device, and
transmit, to the device, the information on the application installable onto the device or the application to be uninstalled from the device.

18. A communication system, comprising:
a device; and
at least one information processing apparatus configured to communicate with the device via a network and provide an application to the device,
the device including
communication circuitry configured to transmit, to the information processing apparatus, a request for information on an application installable onto the device or information of an application to be uninstalled from the device, and
installation control circuitry configured to perform at least one of a process of installing the application onto the device or a process of uninstalling the application from the device, in accordance with the information, on the application installable onto the device or the application to be uninstalled from the device, received from the information processing apparatus,
wherein the installation control circuitry is configured to uninstall the application based on source information indicating an installation source of the application installed on the device, in addition to the information received from the information processing apparatus.
